(19) United States
(12) Patent Application Publication
(10) Pub. No.: US 2012/0120665 A1
(43) Pub. Date: May 17, 2012

(54) LIGHTING SYSTEM

(75) Inventors: Marcellinus Petrus Carolus Michael Krijn, Eindhoven (NL); Fetze Pijlman, Eindhoven (NL)

(73) Assignee: KONINKLIJKE PHILIPS ELECTRONICS N.V., EINDHOVEN (NL)

(21) Appl. No.: 13/322,600

(22) PCT Filed: May 21, 2010
(86) PCT No.: PCT/IB2010/052279

§ 371 Date: Feb. 1, 2012

(30) Foreign Application Priority Data
May 27, 2009 (EP) 09161203.6

(51) Int. Cl. F21V 7/00; F21V 5/02; F21V 5/00

(52) U.S. Cl. 362/296.01; 362/311.01; 362/311.06

(57) ABSTRACT

The invention relates to a lighting system comprising: -a light source (1) to emit light; -a transparent first optical element (3) comprising at least one bounded space (5) filled with blue phase mode liquid crystal material, wherein at least a part of the emitted light successively passes a first boundary surface (6) and a second boundary surface (7) of the bounded space, said first boundary surface being unparallel to said second boundary surface; and—electric means (9-12) to apply an electric field to the bounded space substantially parallel to a direction of the emitted light incident on the first boundary surface of the at least one bounded space.

### FIELD OF THE INVENTION

The invention relates to the field of lighting systems, and more specifically to the field of directable spotlights.

### BACKGROUND OF THE INVENTION

Lighting systems, especially spotlights, are used for instance by architects, interior designers as well as end-users for creating a desired interior style. As the spot produced by lighting systems in general is fixed both in direction and beam divergence, said lighting systems are aimed at a target by tilting and rotating the lighting system as a whole, resulting in a rather bulky mechanical arrangement for controlling the direction of light emitted by the lighting system.

Recent advances in lighting technology, especially in the field of light emitting diodes (LEDs) and LED-based luminaires, have enabled flat and compact lighting systems that are easy to install and less obtrusive than conventional lighting systems.

However, the use of the bulky mechanical arrangement for controlling the direction of light prevents the lighting systems from becoming really flat and compact. This problem is for instance solved by reference US 2008/0198280, which shows a lighting system in which an electrically adjustable optical element comprising a cell with a liquid crystal gel is arranged to adjust a beam of light from a light source. By applying an electric field to the cell, the orientation of the polymers in the liquid crystal gel is changed, so that the scattering pattern of the beam of light can be varied.

A limitation of the lighting system of US 2008/0198280 is that with a single cell only the direction of light with a certain polarization can be changed. The direction of light having a perpendicular polarization is independent of the applied electric field and can thus not be changed by a single cell.

Another disadvantage may be that the current lighting systems require an alignment layer to align molecules of the materials used in the cells. The alignment layer is a very thin layer, sometimes a monolayer, generally made of poly-imide, and is rubbed to align the molecules of the alignment layers. When a liquid crystal material for the cell is deposited on top of the alignment layer, the molecules of the liquid crystal material will align themselves to the alignment layer, so that a distinct state is provided when no electric field is applied. When an electric field is applied, the molecules of the liquid crystal material will align themselves to the electric field. Providing the alignment layer and subsequently adapting the layer is a complex manufacturing step.

### SUMMARY OF THE INVENTION

It would be desirable to provide a compact lighting system that is able to change the direction of a beam of light independent of the polarization of the light beam. It would also be desirable to provide a compact lighting system that is easier to manufacture.

To better address one or more of these concerns, in a first aspect of the invention, a lighting system is provided that comprises:
a light source to emit light;
a transparent first optical element comprising at least one bounded space filled with blue phase mode liquid crystal material, wherein at least a part of the emitted light successively passes a first boundary surface and a second boundary surface of the bounded space, said first boundary surface being unparallel to said second boundary surface; and
electric means to apply an electric field to the bounded space in a direction substantially parallel to a direction of the emitted light incident on the first boundary surface of the at least one bounded space.

In a second aspect of the invention an optical element is provided comprising at least one bounded space filled with blue phase mode liquid crystal material, wherein light successively passes a first boundary surface and a second boundary surface of the bounded space, said first boundary surface being unparallel to said second boundary surface.

In a third aspect of the invention an armature is provided comprising at least one lighting system, said lighting system comprising:
a light source to emit light;
a transparent first optical element comprising at least one bounded space filled with blue phase mode liquid crystal material, wherein at least a part of the emitted light successively passes a first boundary surface and a second boundary surface of the bounded space, said first boundary surface being unparallel to said second boundary surface; and
electric means to apply an electric field to the bounded space in a direction substantially parallel to a direction of the emitted light incident on the first boundary surface of the at least one bounded space.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts a schematic representation of a lighting system according to an embodiment of the invention;

FIG. 2 depicts a schematic representation of a lighting system according to another embodiment of the invention;

FIG. 3 depicts a detailed cross sectional view of a first optical element of the lighting system of FIG. 2; and

FIG. 4 depicts an optical element according to an embodiment of the invention.

### DETAILED DESCRIPTION OF EMBODIMENTS

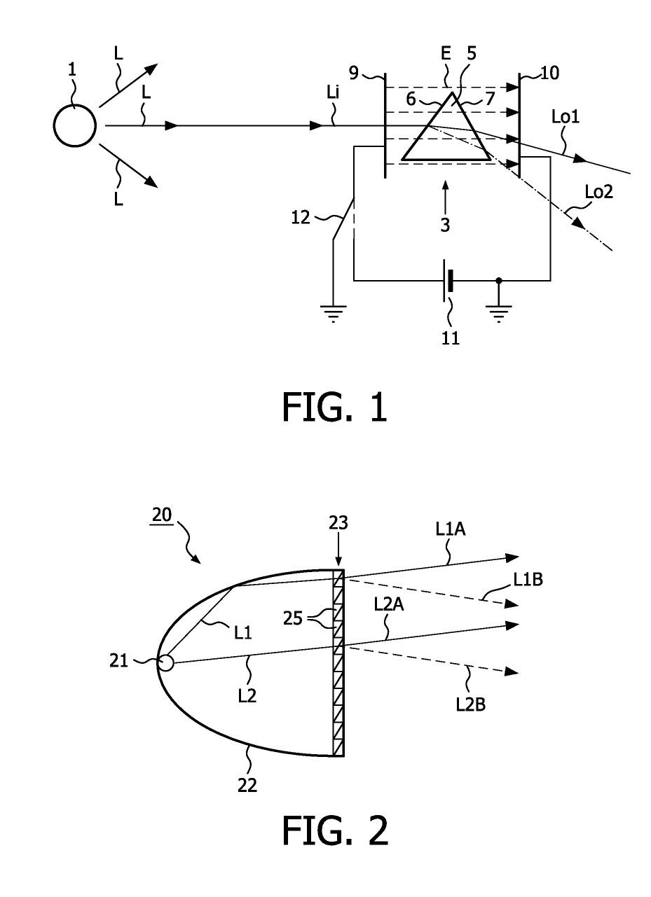

FIG. 1 depicts a schematic representation of a lighting system according to an embodiment of the invention. The lighting system comprises a light source 1 to emit light (indicated by light rays L), and a transparent first optical element 3 comprising at least one bounded space 5 filled with blue phase mode liquid crystal material, wherein at least a part of the emitted light L successively passes a first plane boundary surface 6 and a second plane boundary surface 7 of the bounded space 5, and wherein the first and second plane boundary surfaces 6,7 are at an angle with respect to each other. The lighting system further comprises electric means 9, 10, 11, 12 to apply an electric field E to the bounded space 5 in a direction substantially parallel to a direction of the emitted light incident on the first plane boundary surface 6 of the at least one bounded space 5 (the emitted light incident on the first plane boundary surface is indicated by light ray Li).

The use of blue phase mode liquid crystal material is advantageous as it enables changing the index of refraction independent of the polarization of the incident light Li, as will be explained below. By changing the index of refraction, the direction of the light after it has passed the bounded space 5 can be varied.

Blue phase mode liquid crystal materials have the property that in the absence of an electric field they have isotropic optical properties, and become birefringent when an electric field is applied to the material. Birefringence is the property that the index of refraction of the material is dependent on the polarization of the light passing through the material. The two extremes of the index of refraction are referred to as nₒ and nₑ, each extreme belonging to a polarization which is perpendicular to the other polarization. The birefringence property is usually used to separate a ray of light into two light rays having distinct polarizations. However, if an optical axis, i.e. axis of anisotropy, is parallel to a propagation direction of the light, the index of refraction is independent of the polarization. Typically, the index of refraction is n=((2n₀²+nₑ²)/3)^{1/2} in the case that no electric field is applied. By applying the electric field substantially parallel to the propagation direction of the light, the optical axis of the material is also substantially parallel to the propagation direction of the light and then results in a typical index of refraction of n=nₒ. Therefore, the index of refraction is dependent on the electric field and can thus be used to influence the direction of the light after it passes the bounded space.

An additional advantage may be that the use of blue phase mode liquid crystal material requires fewer components to change the direction of all the emitted light and is thus easier to manufacture, as neither polarizing filters, polarization changers, nor an additional optical element for light having a perpendicular polarization, are required to change the direction of all the light passing the optical element(s). In addition, the optical element does not comprise an alignment layer to align the molecules of the material inside the bounded space, because the molecules of the blue phase mode liquid crystal material do not have to be aligned, which further simplifies the manufacturing process.

In FIG. 1, the bounded space 5 is shown in a side view. The bounded space 5 has a triangular cross section, and preferably the first and second plane boundary surfaces 6, 7 are perpendicular to said triangular cross section, so that the bounded space has a geometric prism shape with a constant triangular cross section. Another type of optical prism can also be used instead.

The electric means comprise two transparent electrodes 9, 10, positioned at either side of the bounded space 5 and perpendicular to the direction of the emitted light (Li) incident on the first plane boundary surface 6. The electric means further comprise a voltage source 11, in this embodiment depicted as a battery, and a switch 12. The switch 12 controls the electric field E between the electrodes 9, 10. If switch 12 is in the position shown in FIG. 1, both electrodes 9, 10 are connected to ground, so no electric field E will be present between the electrodes 9, 10. The material in the bounded space 5 then has isotropic properties and an index of refraction n=((2n₀²+nₑ²)/3)^{1/2}, resulting in light Li passing the bounded space 5 and being deflected in a direction indicated by light path Lo1. When the switch 12 connects a port of voltage source 11 to electrode 9 as indicated by the dashed line of switch 12, the electrodes 9, 10 are both connected to the battery 11 and the electric field E is established. This changes the index of refraction to n=n₀, and the light Li is now deflected along light path Lo2 by way of example. The advantage is that the direction of all the light is changed from light path Lo1 to Lo2, independent of the polarization of the light.

Directions in between light paths Lo1 and Lo2 are also possible and can be controlled by the strength of the electric field E. The electric means therefore preferably comprise an adjuster (not shown) to adjust the strength of the electric field E, thereby allowing a sliding deflection range from Lo1 to Lo2, depending on the strength of the electric field E, until saturation occurs and the index of refraction will not change anymore despite the increase in strength of the electric field E. The adjuster may be able to adjust the applied voltage and/or adjust the distance between the electrodes 9, 10.

It is further noted that if the electric field is oppositely directed, this has no influence on the working principle. It is therefore possible to apply an AC electric field having a square wave form. This has the advantage that it prevents undesired conduction of ions in the blue phase mode liquid crystal material. Typically, frequencies of 50-1,000 Hz are used.

The lighting system may further comprise a transparent second optical element (not shown) positioned such that light traveling along light paths Lo1 and/or Lo2, or in between these light paths Lo1 and Lo2, passes the second optical element. The second optical element preferably is identical to the first optical element and has corresponding electric means. If a bounded space of the second optical element is oriented in the same way, such that it is also able to deflect light in the plane of FIG. 1 as the bounded space 5 of the first optical element, the total deflection range of the lighting system can be increased. The bounded space of the second optical element can also be rotated, for instance through 90 degrees, about an axis parallel to light incident on a first plane boundary surface of the bounded space of the second optical element to deflect light in a direction out of the plane of FIG. 1. This has the advantage that light can be directed in all directions within the deflection ranges of the first and second optical element.

If all emitted light L of the light source passes through the first optical element, and through the second optical element, if applicable, the lighting system may be used as a spotlight, of which the direction of light is electrically adaptable. In case the light source is a flat compact light source, such as an LED, a compact lighting system can be achieved without bulky mechanical arrangements.

FIG. 2 depicts a lighting system 20 according to another embodiment of the invention. The lighting system comprises a light source 21 in the form of a LED, and a collimator 22 to collimate light emitted by the light source 21 as is indicated for two possible light paths L1 and L2. Light path L1 is reflected off the collimator 22 to travel substantially in the same direction as light path L2.

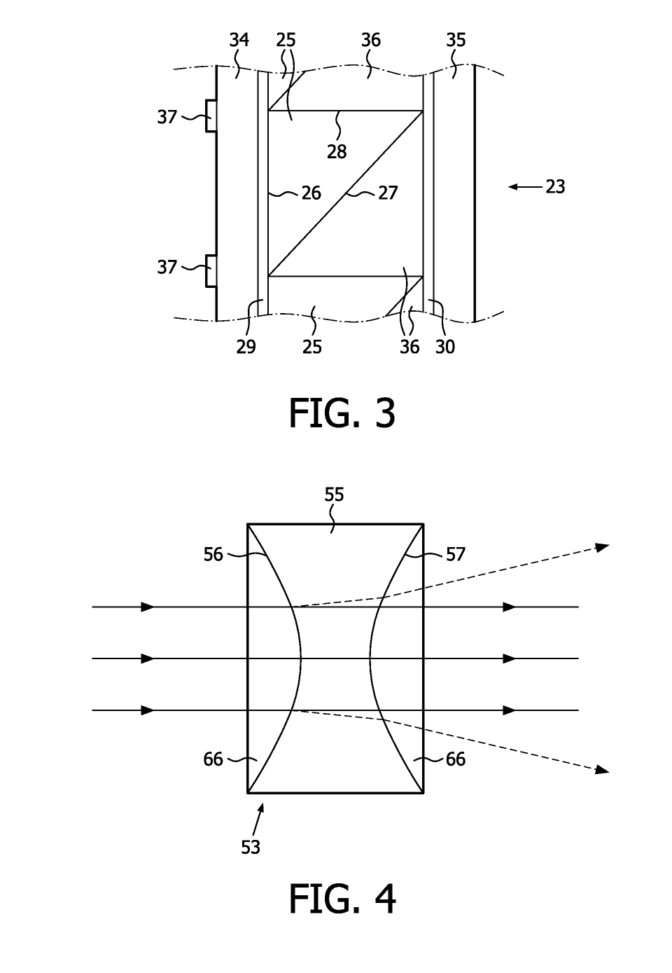

At one end of the collimator 22, a transparent first optical element 23 is provided such that substantially all light emitted by the light source passes the first optical element 23. The first optical element 23 comprises multiple bounded spaces 25 filled with blue phase mode liquid crystal material, of which two bear a reference numeral. The multiple bounded spaces 25 are provided in an array, so that each bounded space covers a part of the end of the collimator 22. The first optical element 23 will be described in more detail below with reference to FIG. 3.

Electric means (not shown) are provided to apply an electric field to the multiple bounded spaces 25 in a direction substantially parallel to a direction of the emitted light incident on a first plane boundary surface of the multiple bounded spaces 25. The electric field is able to change an index of refraction of the blue phase mode liquid crystal material inside the multiple bounded space, so that the direction of light passing the first optical element 23 can be varied between light paths L1A and L1B, and between L2A and L2B for light paths L1 and L2, respectively.

FIG. 3 depicts a detailed view of a cross section of the first optical element 23 of the lighting system of FIG. 2. In FIG. 3, the light source 21 (not shown) is located to the left of the first optical element 23, although alternatively an embodiment in which the light source is located on the right is also possible.

The first optical element 23 comprises multiple bounded spaces 25, of which one is shown completely, and two adjacent ones are shown partially. The bounded spaces 25 are filled with the blue phase mode liquid crystal material.

The first optical element 23 also comprises regions 36 which are filled with another material, preferably a material having an index of refraction which is independent of an applied electric field. The regions are complementary to the bounded spaces 25 to form a layer having a uniform thickness.

The bounded space 25 has a triangular cross section, a first plane boundary surface 26, and a second plane boundary surface 27. The first and second plane boundary surfaces 26, 27 are at an angle with respect to each other and perpendicular to the triangular cross section. The first plane boundary surface 26 is oriented substantially perpendicularly to light incident on the first plane boundary surface 26, so that refraction of light will only occur at the second plane boundary surface 27 if there is a difference between the index of refraction of the blue phase mode liquid crystal material and the index of refraction of the material of the regions 36. Due to the shape of the bounded spaces 25, the direction of light passing the bounded spaces 25 can only be changed in the plane of the drawing.

The bounded spaces 25 and the regions 36 are sandwiched between two transparent electrodes 29, 30, which are part of electric means to apply an electric field to the bounded spaces 25. The electrodes 29, 30 are thus integral with the first optical element 23. The electrodes 29, 30 are protected by respective cover layers 34, 35. Preferably, the index of refraction of the cover layers 34, 35, the electrodes 29, 30, and the regions 36 are substantially equal, so that a possible deflection is only caused at the second plane boundary surface 27.

The first plane boundary surfaces 26, 27 of the multiple bounded spaces 25 are adjacent to each other, so that the perimeters of the adjacent first plane bounded surfaces touch each other. In this way it is prevented that light passes the first optical element without passing a bounded space and the direction of that light thus cannot be controlled by the application of the electric field.

The perimeter of the first plane boundary surfaces can also be protected by providing a reflective layer 37 at the perimeter of the first plane boundary surfaces, said reflective layer facing the light source. The reflective layer 37 reflects the emitted light from the light source at the perimeter and thereby prevents light from passing through or reflecting from third boundary surface 28, which would result in another direction of propagation of the light than that of light passing the first and second plane boundary surfaces. It is then also possible that there is a gap between adjacent first plane boundary surfaces, wherein the reflective layer covers that gap. Light reflected by the reflected layer 37 will eventually pass the first optical element as it will be reflected back by the collimator.

It is also possible to omit the reflective layer and choose the materials such that the index of refraction of the blue phase mode liquid crystal material is higher than the index of refraction of the surrounding material, so that total internal reflection will occur at the third boundary surface 28 for light substantially parallel to the third boundary surface 28, thereby minimizing the disturbing effect of this boundary surface.

FIG. 4 depicts an optical element 53 according to another embodiment of the invention. The optical element comprises a bounded space 55 filled with blue phase mode liquid crystal material, wherein light successively passes a first boundary surface 56 and a second boundary surface 57 of the bounded space 55, said first boundary surface 56 being unparallel to said second boundary surface 57.

The bounded space 55 in this embodiment has the shape of an optical lens, in particular a negative optical lens wherein a convex side of the first boundary surface 56 faces a convex side of the second boundary surface 57. Other lens shapes are also envisaged, for instance positive lenses in which a concave side of the first boundary surface faces a concave side of the second boundary surface. The bounded space 55 is sandwiched between two complementary spaces 66 to form a layer having a uniform thickness and outer sides which are parallel to each other.

Similar to the embodiments of FIGS. 1-3, the optical element 53 is suitable for a lighting system according to the invention. In this embodiment, the index of refraction of the blue phase mode liquid crystal material is chosen to be substantially equal to the index of refraction of the material inside the spaces 66 when no electric field is applied. In this case, light passing the optical element 53 will not change direction (see solid lines). Preferably, the index of refraction of the material inside the spaces 66 is independent of an applied electric field.

When an electric field is applied, the index of refraction of the blue phase mode liquid crystal material will change so that the direction of light is changed to for instance the dashed lines. It is therefore possible to change a lighting system from a spotlight-type of system having a substantially narrow beam to a diffuser-type of system having a substantially wide beam or vice versa by adjusting the applied electric field. The advantage is that the direction of light can be changed independent of the polarization of the light.

In an embodiment of the invention, a control system may be provided to control the electric means and thereby control the applied electric field.

An armature may be configured to house multiple lighting systems according to the invention, wherein each lighting system may have its own control system, but wherein it is also possible that a single control system is provided which is shared by the multiple lighting systems to control the individual electric means of the lighting systems.

By choosing the indices of refraction of various components of an optical element, the deflection range can be set. According to an example, the materials are chosen such that when no electric field is applied, the indices of refraction of all the components of the optical element are the same, resulting in light passing the optical element without being deflected when no electric field is applied. It is also possible to choose the indices of refraction such that the blue phase mode liquid crystal material has a different index of refraction when no electric field is applied with respect to other components of the optical element. A skilled person will easily understand that the choice of materials will influence the deflection range and thus a desired deflection range can be obtained by choosing appropriate materials.

As required, detailed embodiments of the present invention are disclosed herein; however, it is to be understood that the disclosed embodiments are merely exemplary of the invention, and that many variations are possible within the scope of the invention. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

A single processor or other unit may fulfill the functions of several items recited in the claims.

1. A lighting system comprising:
a light source to emit light;
a transparent first optical element defining at least one space having a first boundary surface and a second boundary surface and being filled with blue phase mode liquid crystal material, wherein at least a portion of the light emitted by the light source successively passes the first boundary surface and the second boundary surface of the bounded space; and
electric means to apply an electric field to the bounded space in a direction substantially parallel to a direction of the emitted light incident on the first boundary surface.

2. The lighting system according to claim 1, wherein the first and second boundary surfaces of the bounded space are substantially planar and disposed at an angle with respect to each other.

3. The lighting system according to claim 2, wherein the at least one bounded space has a geometric prism shape with a triangular cross section, and wherein the first and second boundary surfaces are perpendicular to said cross section.

4. The lighting system according to claim 1, wherein portions of the first optical element other than the at least one bounded space have an index of refraction which is independent of the electric field.

5. The lighting system according to claim 1, wherein portions of the first optical element other than the at least one bounded space have substantially the same index of refraction.

6. The lighting system according to any of the claims 1, wherein substantially all the emitted light passes the at least one bounded space.

7. The lighting system according to claim 1, wherein multiple bounded spaces are provided in an array, and wherein the orientation of the multiple bounded spaces is similar.

8. The lighting system according to claim 1, wherein the electric means comprise two transparent electrodes arranged on either side of the at least one bounded space and perpendicular to the direction of the emitted light incident on the first boundary surface.

9. The lighting system according to claim 1, wherein the electric means are configured to apply an AC electric field with a square wave form.

10. The lighting system according to claim 1, comprising a collimator to collimate the emitted light before it is incident on the first optical element.

11. The lighting system according to claim 1, comprising a reflective layer, said layer facing the light source and being arranged between the light source and the first boundary surface of the at least one bounded space to reflect the emitted light at the perimeter of the first boundary surface.

12. The lighting system according to claim 1, wherein a transparent second optical element, which is similar to the first optical element, is provided with corresponding electric means after the first optical element, so that the emitted light first passes the first optical element and then the second optical element.

13. The lighting system according to claim 1, comprising a control system to control the electric means.

14-15. (canceled)

16. The lighting system according to claim 1, wherein the first boundary surface is not parallel to the second boundary surface.
